(19) United States
(12) Patent Application Publication
(10) Pub. No.: US 2004/0069569 A1
(43) Pub. Date: Apr. 15, 2004

(54) Ladder attachment

(76) Inventor: Harry Arthur Fraser, Norwood, MA (US)

Correspondence Address: HARRY A. FRASER, 742 NEPONSET STREET, NORWOOD, MA, 02062, US

(21) Appl. No.: 10/190,997

(22) Filed: Oct. 15, 2002

(51) Int. Cl. E06C 5/32

(52) U.S. Cl. 182/129

(57) ABSTRACT

A comfort attachment for a ladder for a worker to stand on. The attachment structure has a large step as may be found on a stairway and vertical cushioned area against which a worker my lean that will provide support for their legs. The attachment is secured to a ladder by means of spring loaded brackets on the top and a bracket on the bottom that fits securely over a ladder rung. When installed the attachment provides a horizontal step to stand on and a vertical cushion to lean against.

### BACKGROUND AND SUMMARY OF THE INVENTION

To All Whom it may Concern

Be it known that I Harry A Fraser a citizen of the United States residing at Norwood in the County of Norfolk and the State of Massachusetts has invented a new attachment for ladders of which the following is a specification.

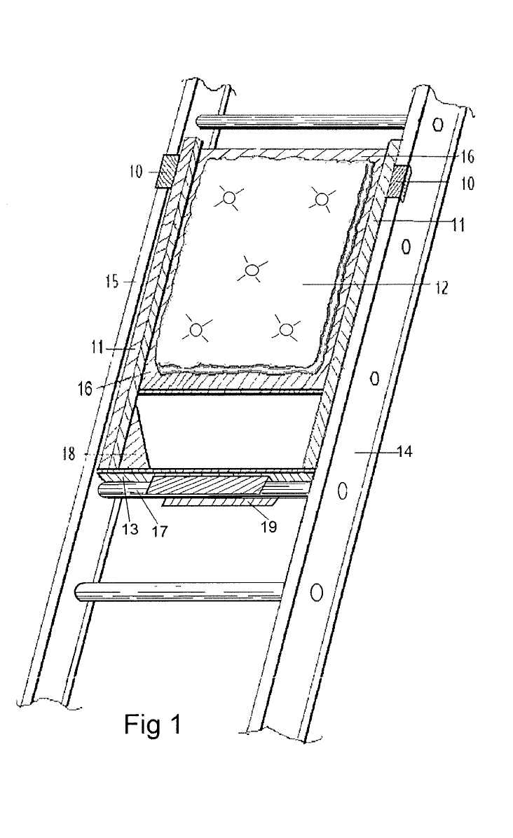

This invention (FIG. 1) relates to an attachment for aluminum that is easy to use and install to be used more particularly by carpenters and painters.

Its object is to provide a wide step and a padded area where the user may stand and lean for long periods in comfort.

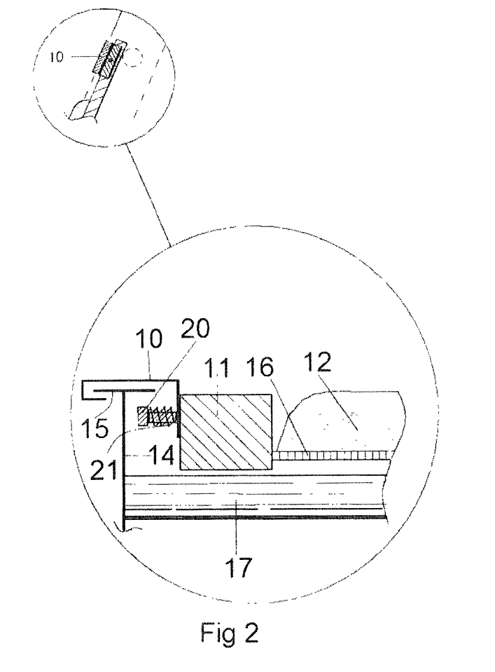

The said attachment being provided on its upper end with a pair of brackets (10) as shown in FIG. 2 which may be easily installed over the top ladder rails (15). When said brackets are installed over the top rails of a ladder they exert the proper pressure by means of compression devices (21) and hinge pins (20) to insure they cannot be accidentally detached. Said brackets have the proper clearance in relation to said top rails as not to bind while said attachment is slid up or down on said top rails.

The plate (16) as shown in FIG. 2 that is the center section of said attachment is attached to the side rails (11). A compressible material (12) that is thick enough to support the weight it may be subject to is attached to said plate.

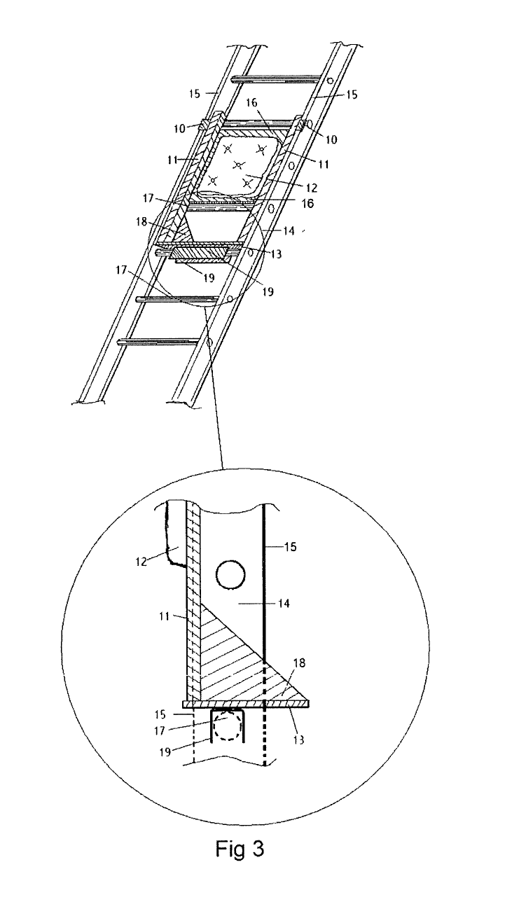

The bottom part of said ladder attachment is in the form of a step (13) as shown in FIG. 3 on which the operator stands. A bracket (19) is attached to the bottom of said step and is fashioned to securely fit over the ladder rung (17). Said step is supported by gussets (18) as shown in FIG. 3 that are secured to both ends of said step (13) and the side rails (11).

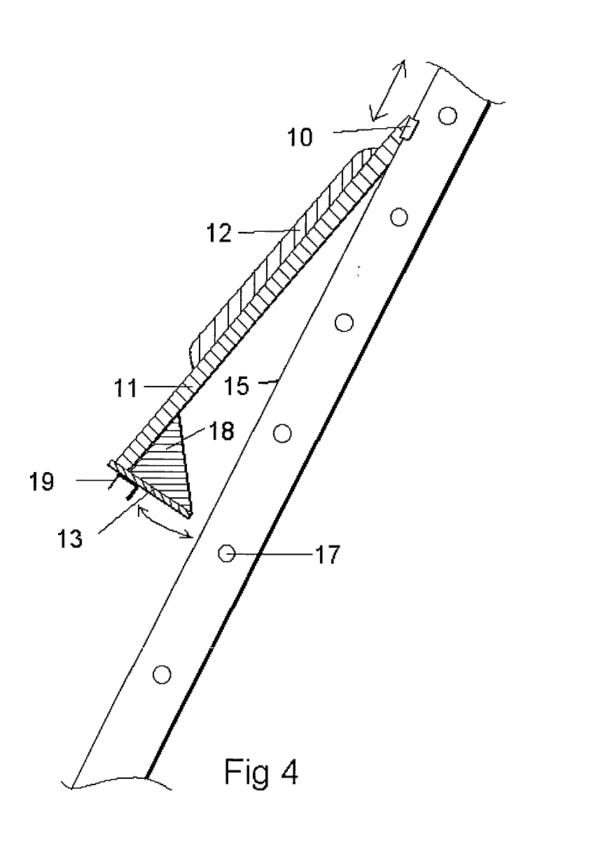

A further object of the invention is when secured to a ladder this attachment may be moved up and down the ladder rails (15) as shown in FIG. 4 by lifting the step (13) up and away from the ladder rung (17) and pushing upwards until the step bracket (19) is just above the rung the operator has chosen to stand on. When said step bracket is in position above said rung it may then be lowered until said step bracket is fully engages over said ladder rung.

A further object of the invention is that the attachment may be secured to a ladder while the operator is on the ground and moved to the top of said ladder to any desired position by sliding the attachment up the ladder as the operator ascends or descends making it unnecessary to carry or detach the said attachment at any time.

What I claim as my invention is an attachment for a ladder comprising:

1. (1) A ladder attachment with a large step and padded area that allows the operator to stand in total safety and comfort for extended periods of time.
b. Spring loaded rollers that attaches to the ladder side rails facilitating the movement of the attachment to any part of the ladder without its having to be removed or re attached.
c. A large padded area supports the operator's knees and shins in comfort.
d. A large step that sits on any ladder rung and is safely secured by means of brackets mounted on the bottom of said step.
